(19) United States
(12) Patent Application Publication
(10) Pub. No.: US 2023/0234543 A1
(43) Pub. Date: Jul. 27, 2023

(54) VEHICLE BRAKING APPARATUS

(71) Applicant: Michel Levesque, Aldergrove (CA)

(72) Inventor: Michel Levesque, Aldergrove (CA)

(21) Appl. No.: 17/585,483

(22) Filed: Jan. 26, 2022

(51) Int. Cl. B60T 7/22; B60T 1/14; B60T 7/20; B60T 11/10

(52) U.S. Cl. CPC B60T 7/22; B60T 1/14; B60T 7/20; B60T 11/10; F16D 2121/14

(57) ABSTRACT

A vehicle braking apparatus that is constructed to be operably coupled to a trailer or a vehicle and provide emergency braking and stoppage thereof. The apparatus of the present invention includes a lever arm that is pivotally coupled to the frame of the trailer or vehicle. The lever arm has secured to the second end thereof an engagement member. The engagement member is planar in manner and configured to be parallel to the road surface. A support member is coupled to the frame and the lever arm and is operable to maintain the lever arm in a downward angled position ensuing the apparatus being placed in its operational position. The vehicle braking apparatus includes a deployment member operable to rapidly deploy the apparatus to its operational position. A biasing member maintains a downward force on the engagement member when the vehicle braking apparatus is in its operational position.

### FIELD OF THE INVENTION

The present invention relates generally to vehicle operational components, more specifically but not by way of limitation, a vehicle braking system that is configured to be automatically deployed and assist in the rapid braking of a vehicle or trailer.

### BACKGROUND

Millions of vehicles and tractor-trailers traverse the roads on a daily basis. In North America alone there are hundreds of thousands of vehicle crashes per year. On average in North America, approximately thirty-eight thousand people die every year from a car crash. Vehicle crashes are the leading cause of death for people of the age between one and fifty. Over half of these crashes result from a vehicle improperly braking and losing control. Approximately twenty percent of the vehicle crashes include a commercial vehicle such as a large tractor-trailer wherein the braking control of the trailer contributed to the crash.

One issue that results in crashes are operators that are distracted and as a result either brake of perform evasive maneuvers to late to avoid an accident. Distracted driving caused by drivers who are texting or engaged with other people in the car causes almost half of all crashes. The seconds lost from being distracted results in the delayed operational movement that needs to be implemented in order to avoid a crash. At highway speeds a vehicle can travel a couple of hundred feet. Delaying a response for a couple of seconds can mean avoiding a crash or becoming involved in a crash. The most common maneuver needed to avoid a crash is braking.

Accordingly, there is a need for a vehicle braking apparatus that can be operably coupled to a vehicle or trailer wherein the apparatus of the present invention is deployed automatically upon detection of a potential collision.

### SUMMARY OF THE INVENTION

It is the object of the present invention to provide a braking apparatus that is configured to be operably coupled to a trailer or vehicle wherein the apparatus of the present invention is configured to be deployed upon detection of a collision so as to provide stoppage of the vehicle and/or trailer.

Another object of the present invention is to provide an emergency braking apparatus for a vehicle or trailer operable to be automatically deployed wherein the present invention is mounted to the underside of the frame of a trailer or vehicle.

A further object of the present invention is to provide a braking apparatus that is configured to be operably coupled to a trailer or vehicle wherein the apparatus of the present invention includes a deployment member wherein the deployment member moves the apparatus from a stored position to an operational position.

Still another object of the present invention is to provide an emergency braking apparatus for a vehicle or trailer operable to be automatically deployed wherein the deployment member includes at least a first embodiment and a second embodiment.

An additional object of the present invention is to provide a braking apparatus that is configured to be operably coupled to a trailer or vehicle wherein the apparatus further includes an engagement member that is configured to be biased against the road surface when the apparatus is in its operational position.

Yet a further object of the present invention is to provide an emergency braking apparatus for a vehicle or trailer operable to be automatically deployed wherein the apparatus further includes a lever arm wherein the lever arm is pivotally coupled to the frame of the vehicle or trailer.

Another object of the present invention is to a provide a braking apparatus that is configured to be operably coupled to a trailer or vehicle wherein the lever arm further includes a support member operably coupled thereto that is configured to retain the lever arm in its second position.

An alternate object of the present invention is to provide an emergency braking apparatus for a vehicle or trailer operable to be automatically deployed wherein the engagement member further has operably coupled thereto a biasing member operable to apply a downward force onto the engagement member when the apparatus is in its operational position.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a side view of the present invention with a first embodiment of the deployment member; and

FIG. 2 is a side view of the present invention with a second embodiment of the deployment member; and

FIG. 3 is a side view of the present invention secured to an exemplary vehicle; and

FIG. 4 is a side view of an alternative embodiment of the present invention; and

FIG. 5 is a top view of the block members of the alternative embodiment of the present invention; and

FIG. 6 is a side view of an alternative embodiment of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a vehicle braking apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring in particular to the Figures submitted herewith, the vehicle braking apparatus 100 is configured to be deployed ensuing detection of a collision of the vehicle 99. It should be understood within the scope of the present invention that the vehicle braking apparatus 100 is communicably coupled to conventional proximity sensors that are installed on the vehicle 99 or trailer 98. Ensuing a signal from the conventional proximity sensors the vehicle braking apparatus 100 is moved from its first position to its second position wherein in the second position the vehicle braking apparatus 100 is operable to stop the vehicle 99 or trailer 98.

The vehicle braking apparatus 100 includes a lever arm 10 that is pivotally coupled to the frame 9 utilizing suitable mechanical fasteners. The lever arm 10 is manufactured from a rigid material such as but not limited to metal and includes a first end 11 and second end 12. First end 11 is pivotally coupled to frame 9 utilizing fastener 8. Lever arm 10 includes an upper surface 13 wherein the upper surface 13 has formed thereon a plurality of protrusions 20. As is further discussed herein, the protrusions 20 are configured to operably couple to the support member 40. In the first position of the vehicle braking apparatus 100 the lever arm 10 is parallel and adjacent the frame 9. In its second position, as is illustrated in the Figures herein, the lever arm 10 has been deployed by the deployment member 30 as is in an angular orientation to the frame 9 wherein the second end 12 is distal thereto.

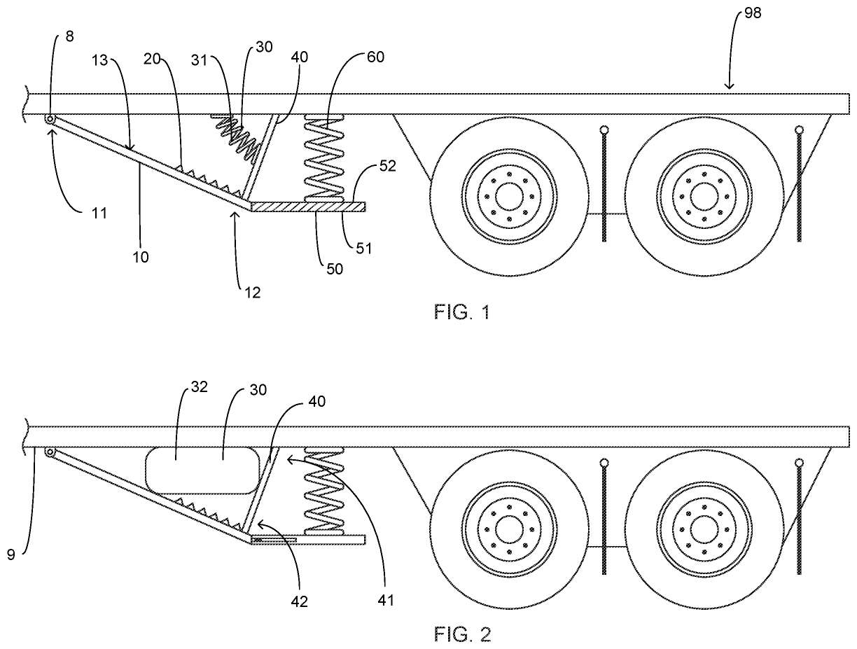

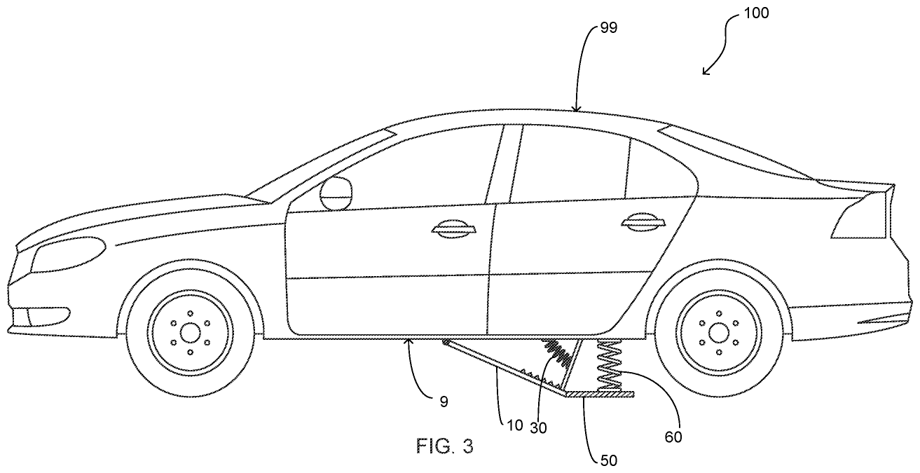

The deployment member 30 is operable to move the lever arm 10 from its first position to its second position and place the vehicle braking apparatus 100 in its operational position. It is contemplated within the scope of the present invention that the deployment member 30 could have a plurality of embodiments, two of which are illustrated in the Figures submitted herewith. The deployment member 30 in one embodiment is a spring 31 wherein the spring 31, illustrated herein in FIG. 1, is maintained in a compressed state and is configured to extend so as to move the lever arm 10 to its second position. Spring 31 is a conventional metal spring and it is contemplated within the scope of the present invention that the spring 31 could be provided in alternate sizes. Furthermore, while one spring 31 is illustrated herein, it is contemplated within the scope of the present invention that more than one spring 31 could be provided to operate the lever arm 10.

An alternative embodiment of the deployment member 30 is air bag 32. The air bag 32 is a conventional vehicular air bag that is configured to be rapidly inflated with a compressed gas source wherein the inflation of the air bag 32 moves the lever arm to its second position. It is contemplated within the scope of the present invention that the air bag 32 could be provided in alternate sizes in order to achieve the desired objective of rapidly moving the lever arm 10 to its second position. The lever arm 10 is operably coupled with support member 40. The support member 40 includes a first end 41 and a second end 42 wherein the first end 41 is pivotally secured to the frame 9 utilizing suitable durable techniques. The second end 42 of the support member 40 engages the protrusions 20 ensuing the lever arm 10 being moved to its second position. The support member 40 inhibits upward movement of the lever arm 10 once the vehicle braking apparatus 100 has been moved to its operational position. The protrusions 20 are formed so as to inhibit movement of the support member 40 ensuing engagement therewith. A plurality of protrusions 20 are formed on the upper surface 13 in order to accommodate various heights of vehicles 99 and trailers 98. It is contemplated within the scope of the present invention that the protrusions 20 could be formed in various shapes and sizes in order to accomplish the desired objective

An engagement member 50 is operably coupled to the second end 12 of the lever arm 10. The engagement member 50 includes a lower surface 51 and an upper surface 52. The engagement member 50 is positioned so as to be generally parallel with a road surface on which the vehicle 99 or trailer 98 is traversing. The engagement member 50 is manufactured from a material such as but not limited to hard rubber. The engagement member 50 is operable to transfer a significant downward force applied thereto by the biasing member 60 so as to provide stoppage of the vehicle 99 or trailer 98. The engagement member 50 is planar in manner and it is contemplated within the scope of the present invention that the engagement member 50 could be provided in alternate sizes and shapes. Furthermore, it should be understood within the scope of the present invention that the engagement member 50 is a wear item and is designed to be replaced after several uses as the material of the engagement member is ablative and will transfer to road surface during engagement therewith.

The biasing member 60 is operably coupled to the upper surface 52 of the engagement member 50 and the frame 9. The biasing member 60 is configured to apply a significant downward force to the engagement member 50 so as to provide stoppage of the vehicle 99 or trailer 98. The biasing member 60 in a preferred embodiment is a metal spring wherein the spring in maintained in a compressed position when the vehicle braking apparatus 100 is in its stored position. Ensuing deployment of the vehicle braking apparatus 100 into its operational position the spring is extended and applies a significant downward force to the engagement member 50. It should be understood that the biasing member 60 could be configured to provide alternate amounts of force depending upon the vehicle 99 or trailer 98 to which the vehicle braking apparatus 100 is operably coupled. While one biasing member 60 is illustrated herein, it should be contemplated within the scope of the present invention that the vehicle braking apparatus 100 could have more than one biasing member 60. Furthermore, it is additionally contemplated within the scope of the present invention that alternate materials and/or elements could be utilized for the biasing member 60.

While the vehicle braking apparatus 100 is illustrated herein as pivoting into its operational position in a particular orientation, it is contemplated within the scope of the present invention that the vehicle braking apparatus 100 could be positioned so as to angle in an orientation one hundred and eighty degrees opposite the illustrated orientation. Furthermore, it is additionally contemplated within the present invention that the engagement member 50 could be configured to operably engage a tire of the vehicle 99 or trailer 98 and utilize for pressure to achieve the desired objective discussed herein. It should further be understood within the scope of the present invention that the vehicle braking apparatus 100 can be returned to its stored position ensuing deployment utilizing various elements such as but not limited to cables and/or electric motors.

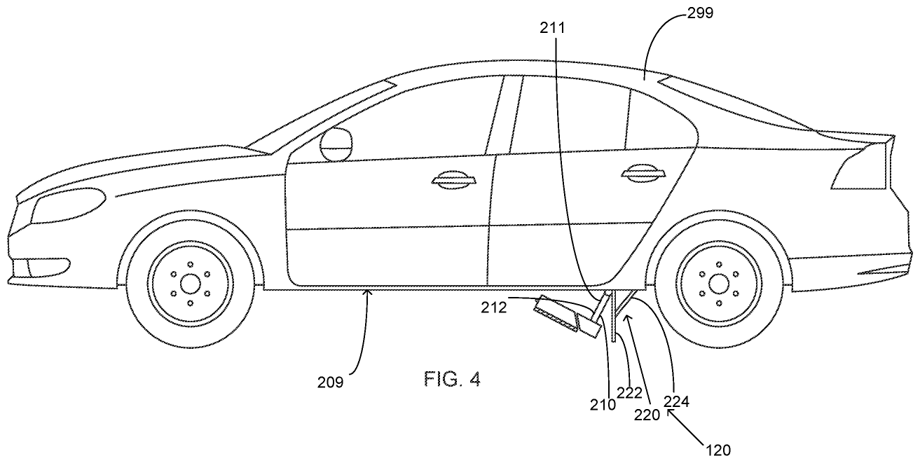

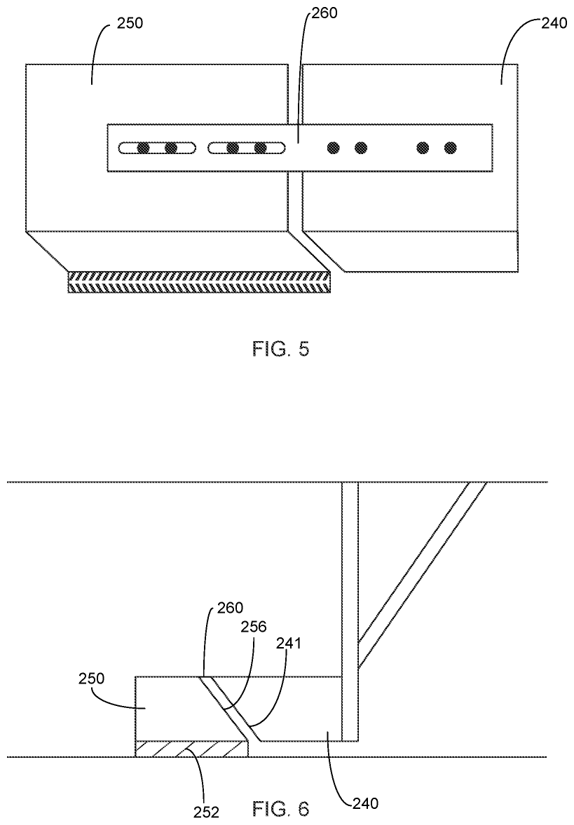

Referring now to FIGS. 4 through FIGS. 6, an alternative embodiment of the vehicle braking apparatus 200 is illustrated therein. The vehicle braking apparatus 200 includes a support member 210 that is hingedly coupled to frame 209 utilizing suitable durable techniques. The support member 210 is manufactured from a rigid material such as but not limited to metal and includes a first end 211 and second end 212. The support member 210 is configured to move from a first position wherein the support member 210 is adjacent the frame 209 to a second position wherein the support member 210 is perpendicular thereto and extending downward therefrom. Secured to the frame 209 rearward of the support member 210 is brace member 220. Brace member 220 is manufactured from metal and includes a first brace member 222 and a second brace member 224. The brace member 220 provides a rearward stopping point for the support member 210 in its second position. The brace member 220 is secured to the frame 209 utilizing suitable durable techniques and it is contemplated within the scope of the present invention that the brace member 220 could be permanently positioned as illustrated or fold down into the position illustrated upon deployment of the vehicle braking apparatus 200.

Secured to the second end 212 of the support member 210 are the first stopping member 240 and the second stopping member 250. The first stopping member 240 is secured to the support member 210 and is immovable with respect thereto. The first stopping member 240 is manufactured from a material such as but not limited to metal and is secured to the second stopping member 250 with bracket 260. The first stopping member 240 includes a front wall 241 that is angular in manner so as to facilitate the desired movement of the second stopping member 250 as discussed further herein. The bracket 260 is structured so as to permit a slidable movement of the second stopping member 250 as discussed herein. It is further contemplated within the scope of the present invention that the second stopping member 250 is configured to breakaway from the first stopping member 240 towards the end of the braking process. It is contemplated within the scope of the present invention is that the second stopping member 250 could be releasably secured utilizing various suitable techniques.

The second stopping member 250 is manufactured from a durable material such as but not limited to metal and includes a bottom surface 252. The bottom surface 252 can be configured to be replaceable and can be manufactured from a rubber or similar material that provides gripping force but is ablative during use of the vehicle braking apparatus 200. The second stopping member 250 includes an angular rear wall 256 that is of a mateable angle with the front wall 241. The angles of the front wall 241 and the rear wall 256 cause the second stopping member 250 to be forced downward ensuing the bottom surface 252 engaging the surface of the road. The results is application of pressure sufficient to stop the vehicle 299. While not illustrated herein, it should be understood within the scope of the present invention that the vehicle braking apparatus 200 is operably coupled to sensors on the vehicle 299 that detect a pending collision and subsequently place the vehicle braking apparatus 200 in position so as to provide stoppage of the vehicle 299.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A vehicle braking apparatus configured to provide emergency braking of a vehicle or trailer wherein the vehicle braking apparatus comprises:
a lever arm, said lever arm being operably coupled to a frame of the vehicle or trailer, said lever arm movable between a first position and a second position;
an engagement member, said engagement member being operably coupled to said lever arm, said engagement member being planar in manner, said engagement member having a lower surface configured to contact a surface on which the vehicle or trailer is traversing when the vehicle braking apparatus is in a second position; and
a deployment member, said deployment member configured to move the vehicle braking apparatus to the second position ensuing detection of a pending collision of the vehicle or trailer with an object.

2. The vehicle braking apparatus configured to provide emergency braking of a vehicle or trailer as recited in claim 1, wherein said lever arm further includes an upper surface, said upper surface having a plurality of protrusions formed thereon, wherein said plurality of protrusions extend upward from said upper surface.

3. The vehicle braking apparatus configured to provide emergency braking of a vehicle or trailer as recited in claim 2, and further including a biasing member, said biasing member being operably coupled to an upper surface of the engagement member, said biasing member further being operably coupled to the frame, said biasing member configured to exert a downward force on said engagement member.

4. The vehicle braking apparatus configured to provide emergency braking of a vehicle or trailer as recited in claim 3, and further including a support member, said support member having a first end and a second end, said first end of support member being pivotally coupled to the frame, said second end of said support member being configured to operably couple said protrusions ensuing said lever arm being moved to its second position.

5. The vehicle braking apparatus configured to provide emergency braking of a vehicle or trailer as recited in claim 4, wherein said deployment member is an air bag.

6. The vehicle braking apparatus configured to provide emergency braking of a vehicle or trailer as recited in claim 5, wherein said biasing member is a spring.

7. The vehicle braking apparatus configured to provide emergency braking of a vehicle or trailer as recited in claim 4, wherein said deployment member is a spring.

8. The vehicle braking apparatus configured to provide emergency braking of a vehicle or trailer as recited in claim 4, wherein said engagement member is manufactured from rubber.

9. A braking apparatus configured to provide emergency braking of a vehicle or trailer that is operable to be deployed ensuing detection of a pending collision wherein the braking apparatus comprises:
a lever arm, said lever arm having a first end and a second end, said first end of said lever arm being operably coupled to a frame of the vehicle or trailer, said lever arm movable between a first position and a second position, said lever arm having an upper surface;
a support member, said support member having a first end and a second end, said first end of support member being pivotally coupled to the frame, said second end of said support member being configured to operably engage the upper surface of said lever arm ensuing said lever arm being moved to its second position;
an engagement member, said engagement member being operably coupled to said lever arm, said engagement member being planar in manner, said engagement member having a lower surface configured to contact a surface on which the vehicle or trailer is traversing when the braking apparatus is in a second position; and
a deployment member, said deployment member being between the frame and said upper surface of said lever arm, said deployment member configured to move the vehicle braking apparatus to the second position ensuing detection of a pending collision of the vehicle or trailer with an object.

10. The braking apparatus configured to provide emergency braking of a vehicle or trailer that is operable to be deployed ensuing detection of a pending collision as recited in claim 9, and further including a plurality of protrusions, said plurality of protrusions being formed on said upper surface of said lever arm, said plurality of protrusions extending upward from said upper surface, said plurality of protrusions configured to operably engage the second end of said support member upon the braking apparatus being moved to its second position.

11. The braking apparatus configured to provide emergency braking of a vehicle or trailer that is operable to be deployed ensuing detection of a pending collision as recited in claim 10, and further including a biasing member, said biasing member being operably coupled to an upper surface of the engagement member, said biasing member further being operably coupled to the frame, said biasing member configured to exert a downward force on said engagement member.

12. The braking apparatus configured to provide emergency braking of a vehicle or trailer that is operable to be deployed ensuing detection of a pending collision as recited in claim 11, wherein the deployment member is selected from one of the following: an air bag or a spring.

13. A vehicle braking apparatus configured to provide stoppage of a vehicle wherein the vehicle braking apparatus comprises:
a support member, said support member having a first end and a second end, said first end being hingedly secured to a frame of the vehicle, said support member being manufactured from metal, said support member being movable between a first position and a second position;
a brace member, said brace member being rearward of said support member, said brace member being secured to the frame of the vehicle, said brace member including a first brace support member and a second brace support member wherein the second brace support member is angularly oriented between the frame and the first brace support member;
a first stopping member, said first stopping member being a block in configuration, said first stopping member being secured to said support member, said first stopping member having a front wall wherein the front wall is angular in orientation; and
a second stopping member, said second stopping member being a block in configuration, said second stopping member having a bottom surface, said second stopping member having an angular rear wall wherein the rear wall is mateable to the front wall of the first stopping member, said second stopping member being movably coupled to said first stopping member so as to apply a downward force on a road surface subsequent deployment of the vehicle braking apparatus.
